(19) United States
(12) Patent Application Publication
(10) Pub. No.: US 2014/0239859 A1
(43) Pub. Date: Aug. 28, 2014

(54) MOTOR DRIVE FOR ON-LOAD TAP CHANGER

(71) Applicant: Dieter Poliwczyk, Regensburg (DE)

(72) Inventor: Dieter Poliwczyk, Regensburg (DE)

(21) Appl. No.: 14/346,110

(22) PCT Filed: Oct. 18, 2012
(86) PCT No.: PCT/EP2012/070673

§ 371 Date: May 12, 2014

(30) Foreign Application Priority Data
Nov. 11, 2011 (DE) 102011118488.4

(51) Int. Cl. H02P 3/12

(52) U.S. Cl. CPC H02P 3/12
USPC 318/379

(57) ABSTRACT

The invention relates to a motor drive for an on-load tap changer with an electrical DC motor and a braking device for denned braking of this motor. According to the invention, the braking device has a first diode (D1), which, depending on the direction of rotation, is connected in series with or in opposition to the armature winding (AW) of the DC motor. In accordance with a further feature of the invention, the braking device has a second diode (D2), which is connected permanently in parallel with the shunt winding (NW) of the DC motor.

The invention relates to a motor drive for an on-load tap changer. Such a motor drive is already known from the applicant's company publication ‘Motorantrieb TAPMOTION® ED, technnische Daten TD 292/01’.

Such a motor drive serves for setting the on-load tap changer to the respectively desired operational setting; all mechanical and electrical subassemblies required for the drive are combined in it. Important mechanical subassemblies of a motor drive of that kind are a load transmission and a control transmission. The load transmission directly actuates the on-load tap changer and for that purpose has an appropriately dimensioned electric motor as drive motor. The control transmission includes a cam control, which in turn has switching cams for actuation of a wide variety of cam switches, these in turn being a component of the electrical subassembly.

The described electric motor of the motor drive is in most cases a three-phase asynchronous motor; DC motors, which can be employed in different output categories, are also known for various cases of use. Such known DC motors have an armature winding, in addition a series winding and a parallel winding. In the case of on-load tap changers with DC motors of that kind a brake device is usually present in the motor circuit, which device guarantees braking of the motor precisely in accordance with intent and prevents it running past the target position. A known brake device of that kind consists of thyristor brake, which comprises an electrical thyristor that is electrically connected in such a manner that in the braking phase the still-present field in the parallel winding of the DC motor is connected in opposition to the existing field. A known thyristor brake is, moreover, equipped with an additional relay that is excited during the braking phase. Ignition of the described thyristor takes place by a special contact at the start of the braking phase. The thyristor brake in principle acts only on the parallel winding of the DC motor.

It is disadvantageous with this known motor drive with the described brake device that on this the one hand, as explained, acts only on the parallel winding and on the other hand is no longer fully functionally capable from about 50 to 55 degrees Celsius.

It is accordingly the object of the invention to indicate a motor drive with a DC motor and a further developed brake device that allows a high level of reliability in a wide temperature range.

This object is fulfilled by a motor drive with the features of the patent claim.

The particular advantage of the invention consists in that the thyristor, which is known in accordance with the prior art, of the brake device is replaced by a novel diode arrangement. In that case, the diodes are connected in such a manner into the motor circuit that the braking phase begins with opening of the motor circuit breaker contacts and the brake device according to the invention acts not only on the series winding, but also equally on the parallel winding. In that case, with particular advantage a directional change of the appropriate diode acting on the series winding takes place by a special brake circuit breaker contact.

The invention will be explained in more detail in the following by way of example on the basis of FIGS., in which:

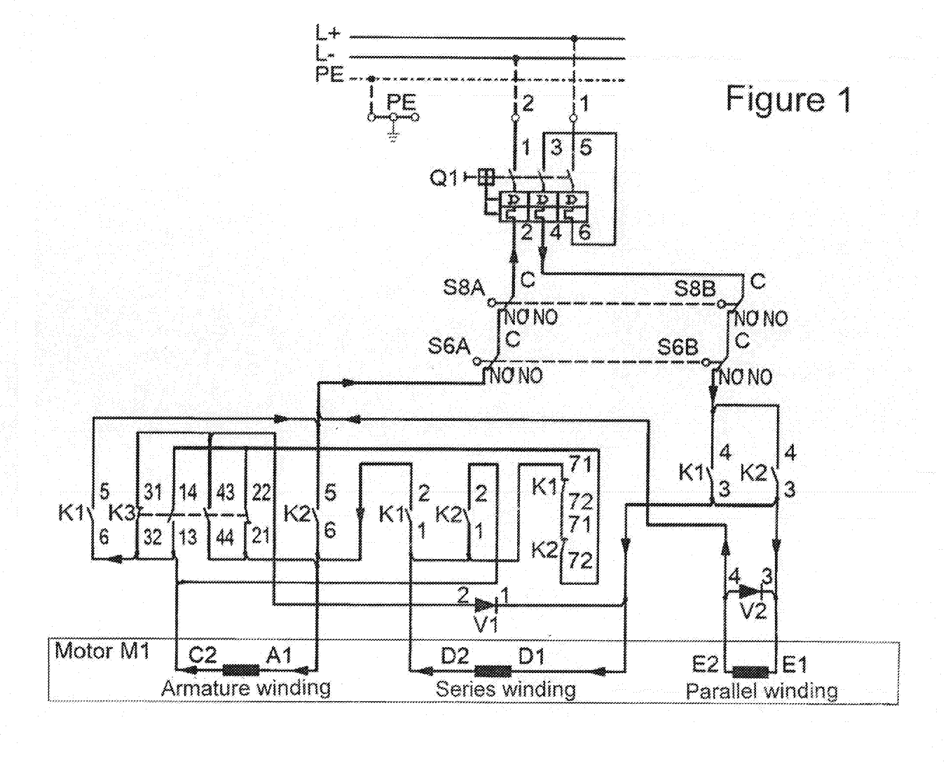

FIG. 1 shows a circuit of a brake device according to the invention in the case of actuation of the motor drive in a first running direction MR−,

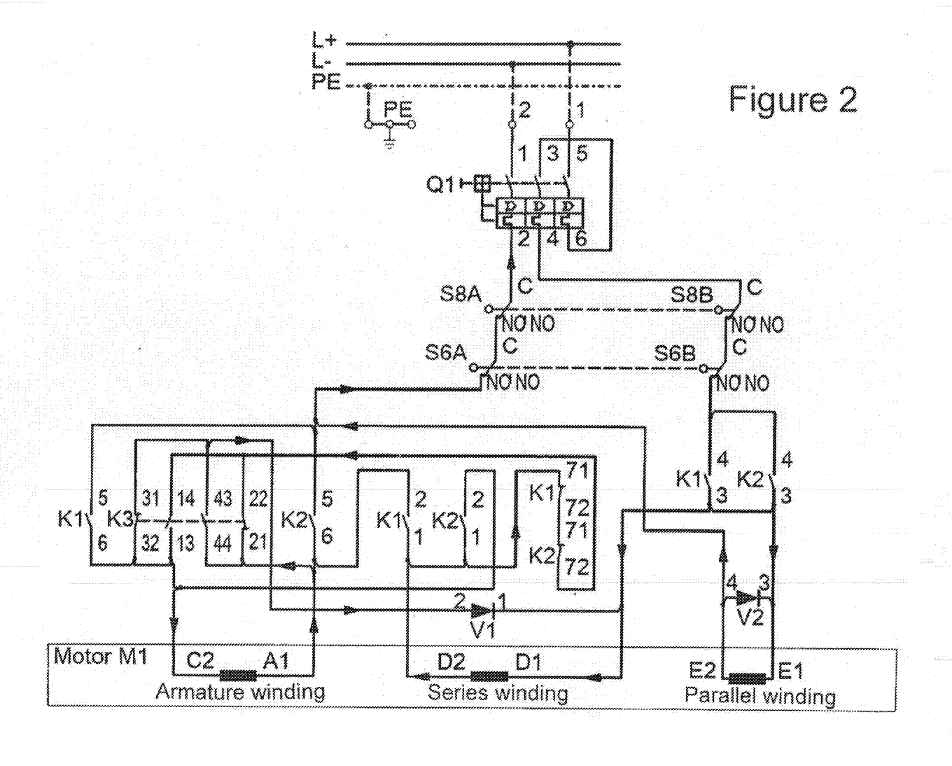

FIG. 2 shows this circuit in the braking phase equally in this running direction MR−,

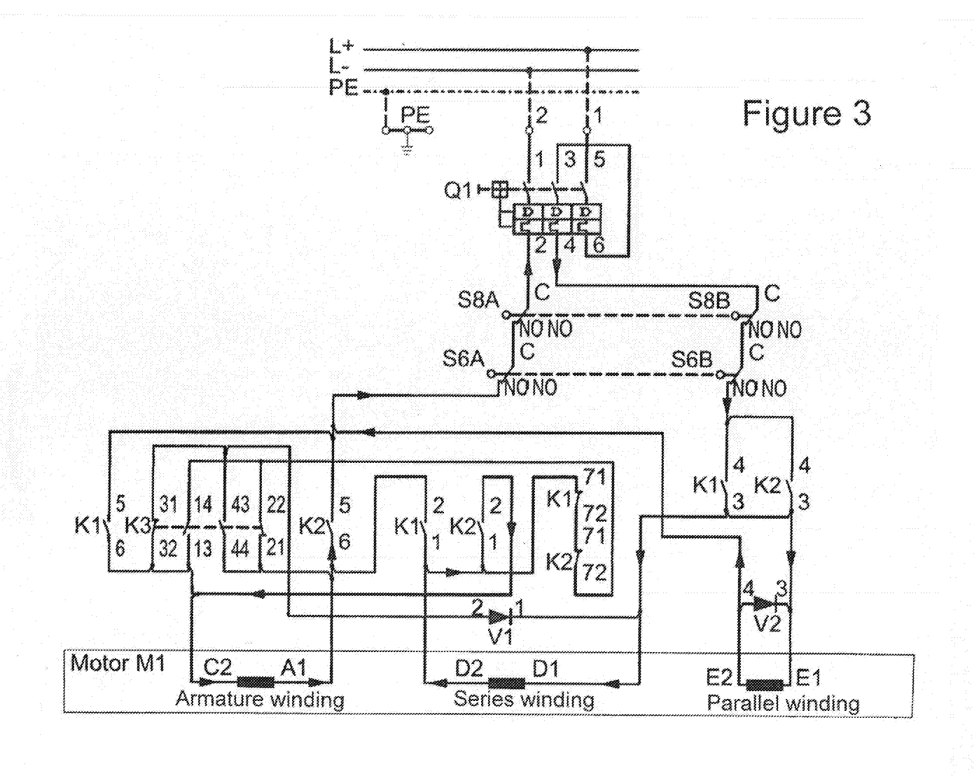

FIG. 3 shows this circuit in the case of actuation of the motor drive in the second running direction MR+ and

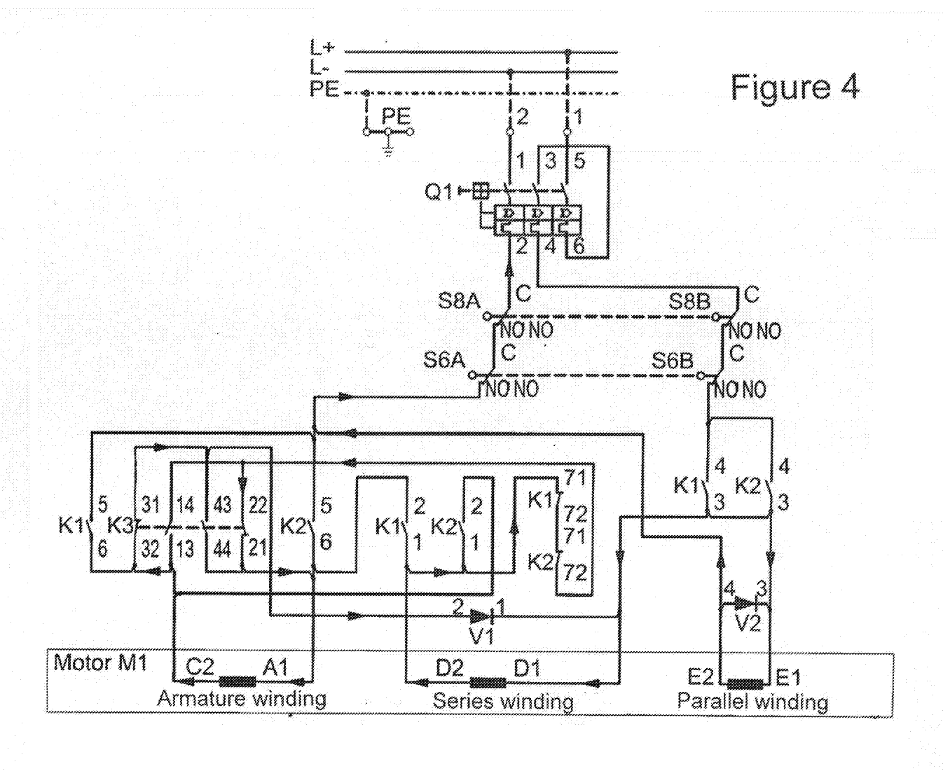

FIG. 4 shows this circuit in the braking phase of this running direction MR+.

The switching state in the case of the running direction MR−, as illustrated in FIG. 1, shall firstly be explained. The voltage path is in that case illustrated in thickened form by + sign to − sign. In this running direction a pulse delivery with respect to the default direction of the first diode V1 is excited by way of closer contacts of a brake relay K3; K3. In addition, the motor relay K1 is excited and armature winding AW and series winding RW are connected in series. The parallel winding NW is connected in.

FIG. 2 shows the braking phase in this running direction. The default direction of the first diode V1 is maintained by way of the closer contacts of the (excited) braked relay K3 and the motor relay K1 drops out. The arrangement of armature winding AW, series winding RW and parallel winding NW remains unchanged. The voltage path is again illustrated in thickened form.

FIG. 3 shows the circuit in the case of an opposite running direction. When pulse delivery takes place a default direction of the diode V1 is released by way of opener contacts of the brake relay K3; K3. The motor relay K2 is excited, the armature winding AW is connected in opposition to the series winding RW and the parallel winding NW is connected in without change. The voltage path in thickened form arises.

Finally, FIG. 4 shows the circuit in the braking phase of the running direction MR+ explained in FIG. 3. The default direction of the diode V1 is maintained by way of the opener contacts of the (dropped-out) brake relay K3. Motor relay K2 drops out and the arrangement of armature winding AW, series winding RW and parallel winding NW remains unchanged. In that case the illustrated voltage path, again illustrated by + to −, results.

In summary, the following functionality of the brake device according to the invention arises: In the braking phase, i.e. after opening of the motor relay contacts K1/K2, the still-present field of the series winding RW is connected in series with the armature winding AW or in opposition to the armature winding AW by the diode D1 and contacts K3 in dependence on the respective rotational direction. The further diode A2 is connected in parallel with the parallel winding NW so as to diminish the still-present field of the parallel winding NW in defined manner in the braking phase. The invention thus enables effective braking of the AC motor by effective influencing of the fields not only of series winding RW, but also of parallel winding NW.

1. A motor drive for on-load tap changer with a load transmission and a control transmission, the load transmission comprising:
an electric direct-current drive motor with an armature winding on the one hand as well as series winding and parallel winding on the other hand; and
an electrical diode brake for the drive motor that in a braking phase electrically acts on the drive motor before a defined new operational setting is reached, the brake having two diodes, in the braking phase, the still-present field of the series winding being connected in series with the armature winding or in opposition to the armature winding by the first diode (D1) depending on rotational direction, the second diode is being permanently connected with the parallel winding.
